(19) United States
(12) Patent Application Publication
(10) Pub. No.: US 2006/0147894 A1
(43) Pub. Date: Jul. 6, 2006

(54) Jacketed vessel for holding semen for sex biasing mammals through artificial insemination and systems and methods for enhancing the probability of sex biasing using the same

(75) Inventor: David Brian Sowter, Vernon, NY (US)

Correspondence Address: EDWARDS & ANGELL, LLP, P.O. BOX 55874, BOSTON, MA, 02205, US

(73) Assignee: VICAM, L.P.

(21) Appl. No.: 11/115,566

(22) Filed: Apr. 26, 2005

Related U.S. Application Data
(60) Provisional application No. 60/641,062, filed on Dec. 30, 2004.

(51) Int. Cl. A01N 1/02

(52) U.S. Cl. 435/2; 435/284.1

(57) ABSTRACT

A jacketed container for holding a semen sample from a mammalian donor at a predetermined temperature for a predetermined period of time prior to incubation to enhance the probability of obtaining offspring of a selected sex through artificial insemination is disclosed. In one embodiment, the semen sample is collected and insulated by a high-heat capacity material that has been preconditioned to a temperature between about 30° C. to about 40° C. before the semen is cooled to a temperature of about 12° C. In a second embodiment, the semen sample is collected and insulated by a high-heat capacity material that has been preconditioned to a temperature between about 4° C. to about 20° C. before the semen is cooled to a temperature of about 12° C.

### RELATIONSHIP TO PREVIOUS APPLICATIONS

The present invention claims priority of provisional U.S. Patent Application No. 60/641,062 entitled “Method for sex biasing of artificial insemination” that was filed on Dec. 30, 2004.

### BACKGROUND OF THE INVENTION

1. Field of the Invention

This invention relates to devices, systems, and methods for enhancing the probability of obtaining offspring of a selected sex. More particularly, this invention relates to devices, systems, and methods for collecting spermatozoa prior to artificial insemination to enhance the probability of obtaining offspring of a selected sex.

2. Background of the Related Art

Agricultural sexing is considered by many to be one of if not the most sought after technology of the current millennium. Indeed, farmers and others practicing animal husbandry have long recognized the desirability of enhancing the probability of obtaining offspring of a selected sex. For example, in the dairy industry, there is a greater demand for milk-producing heifers than for their male counterparts. Consequently, there is a need for methods and devices to artificially bias the sex of mammalian offspring with a high degree of certainty.

In mammals, the male gamete, or spermatozoan controls the sex of offspring. Each spermatozoan contains either an X-type or a Y-type sex-determining chromosome. An X-chromosome spermatozoan creates female offspring after fertilization with an oocyte, whereas a Y-chromosome spermatozoan creates male offspring after fertilization. Methods have been proposed for increasing the percentage of X-chromosome bearing sperm cells or Y-chromosome bearing sperm cells to achieve a greater probability of achieving female or male offspring, respectively.

For example, previous methods have included methods based upon density sedimentation. See, for example, Brandriff, B. F. et al. “Sex Chromosome Ratios Determined by Karyotypic Analysis in Albumin-Isolated Human Sperm,” Fertil. Steril., 46, pp. 678-685 (1986), which is incorporated herein by reference.

U.S. Pat. No. 3,687,806 to Van Den Bovenkamp discloses an immunological method for controlling the sex of mammalian offspring using antibodies that react with either X-bearing sperm or Y-bearing sperm, which utilizes an agglutination step to separate bound antibodies from unaffected antibodies.

U.S. Pat. No. 4,083,957 to Lang discloses a method of altering the sex ratio in animal (including human) offspring by separating the population of spermatozoa into fractions that differ by the sex-linked electrical charge resident thereon. The separation is carried out by bringing the spermatozoa into close association with an electrostatic charge-bearing material having a charge the sign of which is opposite to the sign of a chosen portion of the spermatozoa, that portion that carries the sex-determining character of the unwanted sex, so as to attract and thereby to permit that portion to be isolated, or put to a disadvantage in the fertilization of ova. Concern is expressed with the selection of the charge-bearing material, the adjustment of the pH and particle size thereof, and the control of the surrounding medium in relation to its influence on the charge characteristics of both the charge-bearing material and the spermatozoa. Lang teaches that spermatozoa having male or female sex-bearing genetic material also have differing electrostatic charges—normally negative for male and positive for female—and, further, uses this teaching for separating male and female spermatozoa with charge-bearing materials.

U.S. Pat. No. 4,191,749 to Bryant discloses a method for increasing the percentage of mammalian offspring of either sex by use of a male-specific antibody coupled to a solid-phase immunoabsorbant material to selectively bind male-determining spermatozoa, while the female-determining spermatozoa remain unbound in a supernatant.

U.S. Pat. No. 5,021,244 to Spaulding discloses a method for sorting living cells based upon DNA capacity, particularly sperm populations to produce subpopulations enriched in X-sperm or Y-sperm by means of sex-associated membrane proteins and antibodies specific for such proteins.

U.S. Pat. No. 5,514,537 to Chandler discloses a method and apparatus for the mechanical sorting of mammalian spermatozoa by sex-type into a fraction enriched in X-chromosome-bearing spermatozoa and into a fraction enriched in Y-chromosome-bearing spermatozoa. Because of their different DNA capacity, Y-chromosome spermatozoa are on average slightly smaller than X-chromosome spermatozoa. According to Chandler, a column can be packed with two sizes of beads. The size of the smaller beads is chosen such that, on average, Y-chromosome spermatozoa will readily fit into the interstices between the smaller beads, whereas X-chromosome spermatozoa, on average, will not readily fit into those interstices. The size of the larger beads is chosen such that the larger beads will readily fit into the interstices between the larger beads and the smaller beads will pass through the interstices. As a result, a liquid sample containing sperm is run through a column so that the liquid first encounters the larger beads, and, subsequently, encounters the smaller beads. The beads act as a sieve, creating a fraction in the larger beads enriched in X-chromosome spermatozoa, and a fraction in the smaller beads enriched in Y-chromosome spermatozoa.

However, these prior art methods often result in insufficient separation of X-sperm and Y-sperm and often damage the sperm, thereby reducing its motility and fertility success rate. As a result, in commonly owned and assigned U.S. Pat. Nos. 6,153,373 and 6,489,092, improved methods for sex determination of mammalian offspring are provided using antibodies coupled to magnetic particles for separation of spermatozoa. These methods use magnetic separation to provide gentle separation of populations of spermatozoa.

Lechniak, et al. in Reprod Dom Anim 38, 224-227 (2003), which is incorporated herein by reference, describe a study to determine whether or not sperm pre-incubation prior to fertilization in vitro (IVF) influences the rate of fertilization, embryo development, and/or the sex ratio among blastocysts. In the study, oocyte-cumulus-complexes (OCC) were aspirated from follicles of slaughterhouse ovaries; collected in Hepes-buffered Ham's F-10; and matured in maturation medium under silicone oil for 24 hours at 39 degrees Centigrade (° C.). Frozen-thawed sperm cells were utilized. After swim-up, the motile fraction of sperm was incubated in Sperm-Talp (no heparin included) at 39° C. for 0, 6 and 24 hours. Sperm count was carried out and sperm motility was evaluated. The number of motile sperm cells was kept similar in each experimental group. The motile spermatozoa decreased with time. It was reported by the authors that, when comparisons between groups were made and the actual sex ratios taken into consideration, there were significantly more female-hatched blastocysts among the 24-hour group than among those of either the 0- or 6-hour pre-incubation groups. Unfortunately, IVF is not a practical procedure for fertilization of large herds.

Therefore, it would be desirable to provide novelty devices, systems, and methods of collecting semen to enhance the probability of sex biasing in artificial insemination.

### SUMMARY OF THE INVENTION

The present invention discloses devices, systems, and methods for collecting and preparing a specimen of semen, i.e., a semen ejaculate, to increase the relative number of offspring of a preferred sex in mammals using artificial insemination (AI). For example, a specimen of semen ejaculate can be collected from a mammalian male donor in a jacketed collection tube having a predetermined collection temperature. After collection, the specimen in the jacketed collection tube can be cooled to a predetermined temperature, typically in the range of about 4° C. to about 20° C.; and the specimen can be incubated at that predetermined temperature for a predetermined period of time, typically in the range of from about 2 hours to about 24 hours. After incubation for the predetermined period of time, the specimen is processed into straws, which are used for artificial insemination in a corresponding female mammal using conventional procedures. Preferably, the straws can be frozen before conventional AI use. By treating the semen ejaculate as described, it has been found that a significant bias can be obtained in producing mammalian offspring of a preferred sex by AI. More important, by controlling the temperature of the semen ejaculate early on in the collection process, the rate of success is significantly improved.

Indeed, in a preferred embodiment of the present application, at time zero, mammalian semen ejaculate can be collected in a collection tube and encased in a jacketed container containing a high-heat capacity material. Preferably, the jacketed container contains a material that retains heat and dissipates heat very slowly. The high-heat capacity material can be preconditioned to about 32° C. or, alternatively, to about 12° C.

More specifically, in one embodiment, the present invention provides a system for collecting and handling a specimen of semen ejaculate useful for artificial insemination to increase the conception of mammalian offspring of a preferred sex, wherein the system comprises an inner collection container for collecting and holding a semen ejaculate from a donor; and an outer, temperature control container that contains a high-heat capacity material for maintaining the specimen of semen ejaculate at a predetermined temperature for a predetermined period of time. Preferably, the high-heat capacity material and outer, temperature control container are preconditioned to a predetermined temperature in the range of about 4° C. to about 20° C. More preferably, the high-heat capacity material and outer, temperature control container are preconditioned to a predetermined temperature in the range of about 30° C. to about 40° C.

In one aspect of this embodiment of the invention, the jacketed inner collection container remains in the high-heat capacity material at one temperature range or the other for a predetermined period of time before the jacketed contained is immersed in a water bath. Preferably, the predetermined period of time before the jacketed container is immersed in a cooling water bath is less than about five minutes. More preferably, the predetermined period of time before the jacketed container is immersed in a cooling water bath is about one minute.

In another embodiment, the present invention provides an apparatus for collecting and handling a specimen of semen ejaculate useful for artificial insemination to increase the conception of mammalian offspring of a preferred sex, wherein the apparatus comprises a collection container for collecting and holding a semen ejaculate from a donor. Preferably, the container includes an outer coating that comprises a high-heat capacity material for maintaining the semen ejaculate specimen at a predetermined temperature for at least a predetermined period of time. In one aspect of this embodiment, the high-heat capacity material comprises a non-toxic refrigerant gel.

Preferably, the high-heat capacity material is preconditioned to a predetermined temperature in the range of about 4° C. to about 20° C. More preferably, the high-heat capacity material is preconditioned to a predetermined temperature in the range of about 30° C. to about 40° C. In one aspect of this embodiment of the invention, the jacketed inner collection container remains in the high-heat capacity material at one temperature range or the other for a predetermined period of time before the coated contained is immersed in a cooling water bath. Preferably, the predetermined period of time before the coated container is immersed in a water bath is less than about five minutes. More preferably, the predetermined period of time before the coated container is immersed in a water bath is about one minute.

In yet another embodiment, the present invention provides a method of collecting and handling a specimen of semen useful for artificial insemination to increase the conception of mammalian offspring of a preferred sex, the method comprising the steps of preconditioning a high-heat capacity material; collecting and handling a specimen of semen useful for artificial insemination; encasing the specimen of semen in the high-heat capacity material; and immersing the encased specimen of semen in a temperature controlled device to cool the specimen of semen in a controlled manner.

### BRIEF DESCRIPTION OF THE DRAWINGS

The invention will be better understood by reference to the following more detailed description and accompanying drawings where like reference numbers refer to like parts:

FIG. 1 is an illustrative embodiment of a jacketed assembly in accordance with the present invention;

FIG. 2 is an exploded view of the jacketed assembly in FIG. 1 in accordance with the present invention;

FIG. 3 is a plan view of a jacketed assembly in accordance with the present invention; and

FIG. 4 is an illustrative embodiment of a coated assembly in accordance with the present invention.

### DETAILED DESCRIPTION OF THE INVENTION INCLUDING PREFERRED EMBODIMENTS

The present invention provides devices, systems, and methods for collecting and incubating competent, viable sperm to fertilize mammalian eggs, e.g., inter alia, eggs in fertile cows, using standard AI techniques currently employed on farms. As noted above, prior methods to bias offspring production often compromise sperm integrity, e.g., sperm motility and/or fertilization ability, so that fertilization utilizing such prior art treated sperm requires complicated techniques such as in vitro fertilization (IVF) or ultrasounding of cows during heat to determine side of ovulation, coupled with introduction of a low sperm dose by high uterine horn insemination into the horn attached to the ovary from which the egg is released. It is impractical, however, to use these methods on dairy farms with working dairy herds. The method of the present invention can be utilized for sperm from a variety of mammalian species, including various livestock, such as cattle and sheep, as well as dogs, cats, horses, swine, and other species. The process also is applicable to humans.

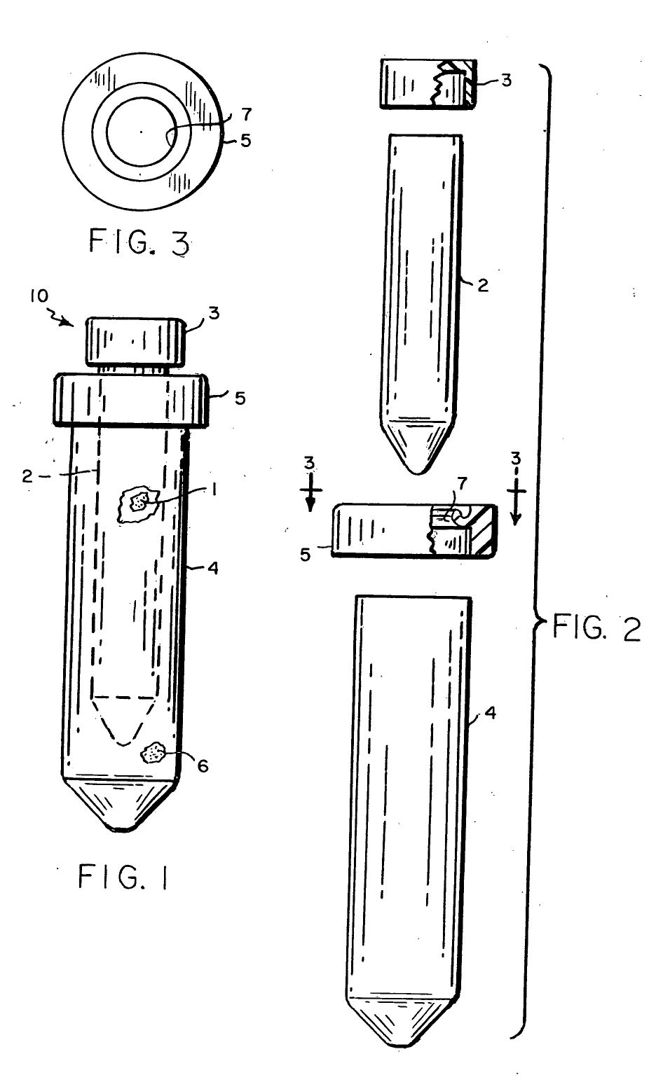

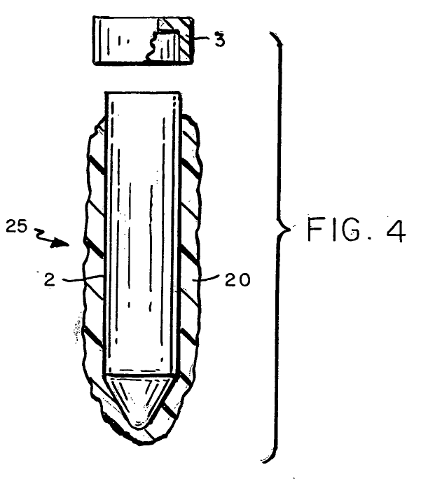

We will now describe a first embodiment of the present invention. Referring to FIGS. 1-3, there are shown a device 4 and system 10 for controlling the temperature of a collected semen ejaculate 1 during a crucial portion of the collection process. In commercial AI applications, semen ejaculate 1 is collected from a male donor, e.g., a proven artificial insemination bull, i.e., an elite bull. Among the methods of collecting semen ejaculate include artificial vaginas, an electro-ejaculator, and the like. With an artificial vagina, typically, the elite bull is induced to complete a false mounting. Subsequently, the semen ejaculate 1 is collected in a collection container 2, i.e., a collection tube 2, that is disposed at the end of the artificial vagina.

Collection tubes 2 can be disposable and, further, can be made of, for example, plastic, resin, glass, polystyrene, polyethylene terephthalate (PET), and the like. PET centrifuge tubes manufactured by Corning of Corning, N.Y. are especially suitable for such use. The size, i.e., volume, of the collection tube 2 can be adjusted for the particular mammal species and the particular donor. Thus, a range of collection tube sizes ranging from about 1 ml to about 25 ml is generally suitable for the present invention. Typically, for a bull, a collection tube 2 in the range between about 10 ml to about 20 ml and, preferably a 15 ml collection tube 2 is suitable.

The assembly 10, further, comprises an outer, temperature control container 4 that is structured and arranged to encompass and/or insulate, i.e., jacket, the inner, collection tube 2. The size, i.e., volume, of the temperature control container 4, or jacket 4, can be selected to be compatible with the size of the collection tube 2. For example, typically, for a 15 ml collection tube 2, a 50 ml jacket 4 can be used. Temperature control containers 4 should be disposable and can be made of, for example, plastic, resin, glass, polystyrene, polyethylene terephthalate (PET), and the like. PET centrifuge tubes manufactured by Corning of Corning, N.Y. are especially suitable for such use.

Preferably, the outer, temperature control container 4, or jacket 4, is larger than the collection tube 2 and contains a high-heat capacity material 6 to control the temperature of the semen ejaculate 1 during a critical portion of the sex biasing process. Any suitable high-heat capacity material 6 can be used in conjunction with the jacket 4 as long as it has adequate heat transfer properties to maintain the semen ejaculate 1 at the desired temperature for a predetermined period of time. In a preferred embodiment, the high-heat capacity material 6 is a viscous gel such as non-toxic refrigerant, phase change gels such as U-TEK® +30° F. or U-TEK® −10° F. or Polar Pack products. Starch-based gels are suitable for this use but they are less preferred because they liquefy with time, which can create a mess. Various materials 6 such as insulating materials also can be used.

Immediately after collection of the semen ejaculate 1 at the artificial vagina but prior to incubation, research performed by the inventors has demonstrated that the semen ejaculate 1 enters a crucial period of the collection process, i.e., a window of opportunity, for the purpose of AI sex biasing. Specifically, the inventors have demonstrated that controlling the temperature of the semen ejaculate 1 immediately after collection and prior to incubation impacts sex biasing. More particularly, the inventors have demonstrated that controlling the temperature of the semen ejaculate 1 during the first minute or two after collection and prior to incubation impacts sex biasing.

In a preferred embodiment, the semen ejaculate 1 is collected in a collection container 2, or collection tube 2 from the end of an artificial vagina (not shown). The collection tube 2 is capped, e.g., using a cap 3, to avoid loss or spillage and, then, quickly encased or immersed in a temperature control container 4 that, preferably, is filled with a high-heat capacity material 6, e.g., a freezer pack gel, that has been preconditioned to a desired temperature. In this embodiment, before collection of the semen ejaculate 1, the temperature control container 4 and the high-heat capacity material 6 are preconditioned, i.e., preheated, to a temperature in the range between about 30° C. and about 40° C., preferably in the range between about 32° C. and about 35° C., e.g., in a water bath (not shown). As a result, when the collection tube 2 containing the freshly collected semen ejaculate 1 is introduced into the high-heat capacity material 6 in the jacket 4, the high-heat capacity material 6 maintains the semen ejaculate 1 at or near preconditioning temperature, which is about the same as the temperature of the semen ejaculate 1 upon ejaculation and collection from the donor.

In one aspect of the present embodiment, the collection tube 2 is inserted through an opening (not shown) in the cap 5 of the temperature control container 4. The opening can be a circular opening, where a substantially circular portion has been removed from the middle portion 7 of the cap 5 or, alternatively, the opening can comprise an “X” pattern that has been cut, e.g., along the diameter of the middle portion 7 of the cap 5. Optionally, to minimize loss by seepage of the high-heat capacity material 6, a gasket or O-ring (not shown) can be included to seal any gaps between the opening in the cap 7 and the outer surface of the collection tube 2. Furthermore, spacers and/or ribs (not shown) can be optionally included in the temperature control container 4 to center the collection tube 2 within the temperature control container 4 to distribute the temperature more uniformly. Such seals, spacers, and ribs are well known to those skilled in the art and will not be described further.

The jacketed collection tube 2, i.e., the assembly 10, is then promptly placed, or immersed, into another temperature-controlled device, e.g., a circulating water bath (not shown), and cooled, as necessary, to a predetermined temperature. Preferably, the temperature of the cooling water bath is in a range between about 4° C. and about 20° C., or, more preferably, in the range between about 6° C. and about 17° C., or, most preferably about 12° C.

Preferably, the collection tube 2 is jacketed in the outer, temperature control container 4, and the entire assembly 10 is placed in a circulating water bath within about 5 minutes of collection of the semen ejaculate 1. More preferably, the jacketed collection tube 2, i.e., the assembly 10, is placed in a circulating water bath within about 3 minutes of collection. Most preferably, the jacketed collection tube 2, i.e., the assembly 10, is placed in a circulating water bath within about 1 minute of collection.

The collected semen ejaculate 1 is then incubated in the cold-water bath, e.g., at about 12° C., for another predetermined period of time. Typically, the predetermined period of time is from about 2 hours to about 24 hours. Preferably, the predetermined period of time is from about 2 hours to about 12 hours. More preferably, the predetermined period of time is from about 2 to about 8 hours. Most preferably, the predetermined period of time is from about 4 to about 6 hours.

After incubation, the cooled semen ejaculate 1 is extended, e.g., using phosphate buffered saline (“PBS”), to the desired volume and straws are prepared according to conventional procedures. The straws can be frozen and stored prior to use for artificial insemination. Typically, the straws are thawed and semen from a straw deposited in the uterus just beyond the cervix.

In another preferred embodiment, the semen ejaculate 1 is collected in a collection container 2, or collection tube 2, from the end of an artificial vagina (not shown). The collection tube 2 is capped, e.g., using a cap 3 to avoid loss or spillage, and, then, encased or immersed in a temperature control container 4 that, preferably, is filled with a high-heat capacity material 6, e.g., a freezer pack gel, that has been preconditioned to a desired temperature. In this embodiment, before collection of the semen ejaculate 1, the temperature control container 4 containing the high-heat capacity material 6 is preconditioned, i.e. pre-cooled, to a temperature in a range between about 4° C. and about 20° C., preferably, in the range of about 6° C. to about 17° C., e.g., in a cool water bath (not shown). As a result, when the collection tube 2 containing the freshly collected semen ejaculate 1 is introduced into the high-heat capacity material 6 in the jacket 4, the high-heat capacity material 6 immediately begins to cool the semen ejaculate 1.

In one aspect of this preferred embodiment, the collection tube 2 is inserted through an opening (not shown) in the cap 5 of the temperature control container 4. The opening can be a circular opening, where a substantially circular portion has been removed from the middle portion 7 of the cap 5 or, alternatively, the opening can comprise an “X” pattern that has been cut, e.g., along the diameter of the middle portion 7 of the cap 5. Optionally, to minimize loss by seepage of the high-heat capacity material 6, a gasket or O-ring (not shown) can be included to seal any gaps between the opening in the cap 7 and the outer surface of the collection tube 2. Furthermore, spacers and/or ribs (not shown) can be optionally included in the temperature control container 4 to center the collection tube 2 within the temperature control container 4 to distribute the temperature more uniformly. Such seals, spacers, and ribs are well known to those skilled in the art and will not be described further.

The jacketed collection tube 2, i.e., the assembly 10, is then promptly placed, or immersed, into another temperature-controlled device, e.g., a circulating water bath (not shown), and cooled, as necessary, to a predetermined temperature.

Preferably, the temperature of the cooling water bath is in a range between about 4° C. and about 20° C., or, more preferably, in the range between about 6° C. and about 17° C., or, most preferably about 12° C. Preferably, the collection tube 2 is jacketed in the outer, temperature control container 4, and the entire assembly 10 is placed in a circulating water bath within about 5 minutes of collection of the semen ejaculate 1. More preferably, the jacketed collection tube 2, i.e., the assembly 10, is placed in a circulating water bath within about 3 minutes of collection. Most preferably, the jacketed collection tube 2, i.e., the assembly 10, is placed in a circulating water bath within about 1 minute of collection.

The collected semen ejaculate 1 is then incubated in the cold-water bath, e.g., at about 12° C., for another predetermined period of time. Typically, the predetermined period of time is from about 2 hours to about 24 hours. Preferably, the predetermined period of time is from about 2 hours to about 12 hours. More preferably, the predetermined period of time is from about 2 to about 8 hours.

Most preferably, the predetermined period of time is from about 4 to about 6 hours.

After incubation, the cooled semen ejaculate 1 is extended, e.g., PBS, to the desired volume and straws are prepared according to conventional procedures. The straws can be frozen and stored prior to use for artificial insemination. Typically, the straws are thawed and semen from a straw deposited in the uterus just beyond the cervix.

Although, up to this point, the invention has been described by introducing a collection tube 2 into a container 4 containing a high-heat capacity material 6 after collection of the semen ejaculate 1, in a second embodiment, referring to FIG. 54, the outer surface of the collection tube 2 can, instead, be coated with a high-heat capacity material 20, e.g. a viscous gel layer, that has sufficient stability to be handled without losing the heat transfer properties of the gel layer 20 and sufficient viscosity to remain in physical communication with the collection tube 2 when it is incubated in a cooling water bath as described above.

For example, a collection tube 2 can be immersed, i.e., dunked, in a high-heat capacity material 6 so that a viscous gel layer 20 adheres to the outer surface of the collection tube 2. Immersion can occur before or after the semen ejaculate 1 is collected. Alternatively, a viscous gel layer 20 of high-heat capacity material 6 can be applied or spread, e.g., using a spatula, on the outer surface of the collection tube 2.

By collecting semen ejaculate 1 using a jacketed assembly 10 or a coated assembly 25 to control and maintain the temperature of the semen 1 immediately after collection and prior to incubation, the spermatozoa of a mammal can be incubated and processed without a substantial loss of quality. Quality includes, but is not limited to: motility, progressive motility, grade of motility, acrosomal integrity, immediate and incubated post-thaw motility, and morphology. Consequently, the quality of the incubated spermatozoa using a jacket assembly 10 is at least about 50% of the unprocessed spermatozoa. Preferably, the functionality of the fractionated spermatozoa is at least about 60% of the unprocessed spermatozoa, at least about 70% of the unprocessed spermatozoa, at least about 80% of the unprocessed spermatozoa, or is at least about 90% of the unprocessed spermatozoa. More preferably, the quality of the fractionated spermatozoa is at least about 95% of the unprocessed spermatozoa, still more preferably is at least about 97% of the unprocessed spermatozoa, yet even more preferably is at least about 98% of the unprocessed spermatozoa, and most preferably is at least about 99% of the unprocessed spermatozoa. Thus, populations of incubated spermatozoa preferentially determinative of one sex having the foregoing levels of quality relative to unprocessed spermatozoa are provided.

The invention will be described further in the following example.

### EXAMPLE 1

Semen ejaculate 1 was collected from proven artificial insemination bulls according to the following procedure.

1. Ejaculate 1 was collected at ambient temperature into a modified collection assembly 10 comprising of a 15 ml collection tube 2 that has been immersed in a container 4 of freezer pack gel 6 that was preconditioned to a temperature of about 32° C. prior to use. Immediately before the ejaculate 1 was collected but after the completion of the required false mountings, the collection apparatus 2 was attached to the end of the artificial vagina and the ejaculate collected.

2. The insulated collection assembly 10 was transferred to a circulating water bath at 12° C. to begin the cooling incubation process.

3. Incubate for 6 hours at 12° C.

4. Prepare straws according to conventional procedures.

Conveniently, a jacketed collection tube 10 was made by filling a 50 ml conical tube 4 with freezer pack gel 6, covering the top with a cap, e.g., a centrifuge tube cap, in which a cross-cut opening was made, and inserting into the gel 6 through the opening a 15 ml conical tube 2 into which the semen 1 was collected.

The collected and incubated semen was extended and frozen using conventional freezing procedures. Straws were prepared at about 20 million sperm cells/straw (calculated).

Cows and heifers in working dairy herds were inseminated with semen by artificial insemination (AI) with the incubated semen and with a control semen. The results of the AI are tabulated in Table 1.

TABLE 1

| | Female | Male | Total | |
|---|---|---|---|---|
| Straw | Feti | Feti | Feti | % Female |
| Sexed | 92 | 53 | 145 | 63.4% |
| Control | 62 | 63 | 125 | 49.6% |

The invention has been described in detail including preferred embodiments thereof. However, modifications and improvements within the scope of this invention will occur to those skilled in the art. The above description is intended to be exemplary only. The scope of this invention is defined only by the following claims and their equivalents.

For example, although the invention has been described having an outer coating 20 or a temperature control device 4, i.e., a jacket 4, the invention is not to be construed as being limited thereto. Indeed, a covering, e.g., a ceramic or polymer covering, can be used in conjunction with the coating 20.

What is claimed is:

1. A system for collecting and handling a specimen of semen useful for artificial insemination to increase the conception of mammalian offspring of a desired sex prior to incubation, the system comprising:
an inner collection container for collecting and holding a semen ejaculate from a donor; and
an outer, temperature control container, containing a material therein that maintains the specimen of semen at a predetermined temperature for at least a predetermined period of time prior to initiation of incubation.

2. The system as recited in claim 1, wherein the material is a high-heat capacity material.

3. The system as recited in claim 1, wherein the material is preconditioned to a predetermined temperature in the range of about 4° C. to about 20° C.

4. The system as recited in claim 3, wherein the predetermined temperature is in the range of about 6° C. to about 17° C.

5. The system as recited claim 4, wherein the predetermined temperature is about 12° C.

6. The system as recited in claim 1, wherein the material is preconditioned to a predetermined temperature in the range of about 30° C. to about 40° C.

7. The system as recited in claim 6, wherein the predetermined temperature is in the range of about 32° C. to about 35° C.

8. The system as recited claim 7, wherein the predetermined temperature is about 32° C.

9. The system as recited claim 1, wherein the predetermined period of time is less than about five minutes.

10. The system as recited claim 9, wherein the predetermined period of time is less than about three minutes.

11. The system as recited claim 10, wherein the predetermined period of time is less than about one minute.

12. A method for increasing the conception of mammalian offspring of a preferred sex, the method comprising:
preconditioning a high-heat capacity material;
collecting and handling a specimen of semen useful for artificial insemination;
encasing the specimen of semen in the high-heat capacity material; and
immersing the encased specimen of semen in a temperature controlled device to cool the specimen of semen in a controlled manner.

13. The method as recited in claim 12, wherein the preconditioning step includes preconditioning the high-heat capacity material to a temperature in the range of from about 30° C. to about 40° C.

14. The system as recited claim 13, wherein the preconditioning step includes preconditioning the high-heat capacity material to a temperature in the range of from about 32° C. to about 35° C.

15. The method as recited in claim 12, wherein the preconditioning step includes preconditioning the high-heat capacity material to a temperature in the range of from about 4° C. to about 20° C.

16. The method as recited in claim 15, wherein the preconditioning step includes preconditioning the high-heat capacity material to a temperature in the range of from about 6° C. to about 17° C.

17. The method as recited in claim 12, wherein the encasing step includes immersing the specimen of semen in a high-heat capacity material that is contained in a temperature control container.

18. The method as recited in claim 12, wherein the encasing step includes encasing the specimen of semen in a high-heat capacity viscous gel.

19. The method as recited in claim 12, wherein the immersion step includes:
placing a jacketed collection tube into the temperature controlled device, and
controlling the temperature of the temperature controlled device in the range of from about 4° C. to about 20° C.

20. The method as recited in claim 19, wherein the immersion step includes:
placing a jacketed collection tube into the temperature controlled device, and
controlling the temperature of the temperature controlled device in the range of from about 6° C. to about 17° C.

21. The method as recited in claim 20, wherein the immersion step includes:
placing a jacketed collection tube into the temperature controlled device, and
controlling the temperature of the temperature controlled device at about 12° C.

22. The method as recited in claim 12, wherein the immersion step is performed for about 2 to about 24 hours to cool the specimen of semen to about 12° C.

23. An apparatus for collecting and handling a specimen of semen useful for artificial insemination to increase the conception of mammalian offspring of a preferred sex, the apparatus comprising:
a collection container for collecting a semen ejaculate from a donor, the container having an outer coating, wherein
the outer coating comprises a material for maintaining the specimen at a predetermined temperature for at least a predetermined period of time.

24. The apparatus as recited in claim 23, wherein the material is a high-heat capacity material.

25. The apparatus as recited in claim 24, wherein the material comprises a non-toxic refrigerant gel.

26. The apparatus as recited in claim 23, wherein the material is preconditioned to a predetermined temperature in the range of about 4° C. to about 20° C.

27. The apparatus as recited in claim 26, wherein the predetermined temperature is in the range of about 6° C. to about 17° C.

28. The apparatus as recited in claim 27, wherein the predetermined temperature is about 12° C.

29. The apparatus as recited in claim 23, wherein the material is preconditioned to a predetermined temperature in the range of about 30° C. to about 40° C.

30. The apparatus as recited in claim 29, wherein the predetermined temperature is in the range of about 32° C. to about 35° C.

31. The apparatus as recited in claim 30, wherein the predetermined temperature is about 32° C.

32. The apparatus as recited in claim 23, wherein the predetermined period of time is less than about five minutes.

32. The apparatus as recited in claim 31, wherein the predetermined period of time is less than about three minutes.

33. The apparatus as recited in claim 32, wherein the predetermined period of time is less than about one minute.
